(19) United States
(12) Patent Application Publication
(10) Pub. No.: US 2016/0226265 A1
(43) Pub. Date: Aug. 4, 2016

(54) METHOD AND POWER CONVERTER FOR PREDICTIVE DISCONTINUOUS CHARGE MODE CONTROL

(71) Applicant: ZENTRUM MIKROELEKTRONIK DRESDEN AG, Dresden (DE)

(72) Inventor: Chris YOUNG, Round Rock, TX (US)

(73) Assignee: ZENTRUM MIKROELEKTRONIK DRESDEN AG, Dresden (DE)

(21) Appl. No.: 15/025,921

(22) PCT Filed: Sep. 29, 2014
(86) PCT No.: PCT/EP2014/070822

§ 371 Date: Mar. 30, 2016

Related U.S. Application Data
(60) Provisional application No. 61/884,260, filed on Sep. 30, 2013.

(51) Int. Cl. H02J 7/00

(52) U.S. Cl. CPC H02J 7/007; H02J 7/0052; H02J 2007/0059

(57) ABSTRACT

A method is provided for controlling a power stage of a power converter configured to generate an output voltage from an input voltage according to a control law controlling a switchable power stage. The method comprises generating a pulsed control signal for switching the power stage by varying a pulse width of the pulsed control signal so that a square of the pulse width is a function of a voltage error control signal derived from a difference between a reference voltage and the output voltage. This is a predictive method of charge mode control. The method is for a modulation scheme that does not require compensation for the discontinuous conduction mode.

### FIELD OF THE INVENTION

The present invention relates to a method and power converter for predictive charge mode control.

### BACKGROUND OF THE INVENTION

Switched DC-DC converters comprise a switchable power stage, wherein an output voltage is generated according to a switching signal and an input voltage. The switching signal is generated in a control circuit that adjusts the output voltage to a reference voltage. A buck converter is shown in FIG. 1. The switched power stage 11 comprises a dual switch consisting of a high-side field effect transistor (FET) 12 and a low-side FET 13, an inductor 14 and a capacitor 15. During a charge phase, the high-side FET 12 is turned on and the low-side FET 13 is turned off by the switching signal to charge the capacitor 15. During a discharge phase the high-side FET 12 is turned off and the low-side FET 13 is turned on to match the average inductor current to the load current. The switching signal is generated as digital pulse width modulation signal with a duty cycle determined by a control law by the controller 16.

The power converter can be operated either in continuous-conduction-mode (CCM) or in discontinuous conduction mode. (CCM) means that the current in the energy transfer inductor substantially never goes to zero between switching cycles, although it may momentarily go through zero while transitioning from a positive to negative current or negative to positive current. In DCM, the current goes to zero during a substantial part of the switching cycle. In buck derived converters as shown in FIG. 1 the major effect is that when it changes from CCM to DCM, it goes from one control law to another. In boost and buck-boost derived systems there is a right-half-plane zero in CCM which is not present in the DCM. This makes it much more difficult to stabilize these converters with good dynamic response.

DCM regulation therefore typically requires compensation that is different from CCM. Thus, transition from discontinuous to continuous conduction mode requires a rapid controlled change in compensation.

### DISCLOSURE OF THE INVENTION

It is an objective of the present disclosure to provide a control method for a power stage of a power converter that improves the transition from discontinuous to continuous conduction mode and vice versa.

This objective is achieved with a method for controlling a power stage according to the independent method claim and a power converter according to the independent apparatus claim. Dependent claims relate to further aspects of the present invention.

The present invention relates to method for controlling a power stage of a power converter configured to generate an output voltage from an input voltage according to a control law controlling a switchable power stage. The method comprises generating a pulsed control signal for switching the power stage by varying a pulse width of the pulsed control signal so that a square of the pulse width of the pulsed control signal yields a charge to be delivered in a cycle in dependence of a voltage error, wherein the charge to be delivered in a cycle depends on the voltage error and the square of the pulse width.

Thus, the square of the pulse width of the pulsed control signal varies in dependence of the voltage error to increase or decrease a charge to be delivered in a cycle. The voltage error is derived from a difference between a reference voltage and the output voltage. The pulse control signal may be cyclic periodic.

This is a predictive method of charge mode control.

Past attempts at charge control have tried to measure the charge as it was delivered. The pulse would be terminated when the measured charge equaled the required value. In this invention, the charge to be delivered is predicted by the system parameters and the programmed pulse width. This simplifies the process because no charge needs to be measured and no fast decisions need to be made about terminating a pulse except the apriori decision to terminate a pulse as predicted by this technique.

The method is for a modulation scheme that does not require compensation for the discontinuous conduction mode.

Thus the requirement of a rapid controlled change in compensation is relieved in that the discontinuous conduction mode does not require compensation.

Specifically, the method may comprise generating the pulsed control signal such that a resulting charge Q, i.e. the charge to be delivered, in a cycle is given by

$$Q = \frac{{V}_{in} - {V}_{out}}{2 L} ( \frac{{V}_{in}}{{V}_{out}} ) {t}_{p}^{2} ,$$

wherein Vᵢₙ is the input voltage, Vₒᵤₜ is the output voltage, L is an inductance of the switchable power stage and tₚ is the pulse width of the pulsed control signal.

The skilled person will appreciate that the equation above is idealized and can be expanded to account for higher order effects and parasitic elements.

When a steady pulse width tₛₛ is determined otherwise, the method may comprise generating the pulse control signal by augmenting the steady state pulse width tₛₛ by an additional on-time t_{d} such that an additional charge Q_{d} in a cycle is given by

$${Q}_{d} = \frac{{V}_{in} - {V}_{out}}{2 L} ( \frac{{V}_{in}}{{V}_{out}} ) {t}_{d} [ 2 {t}_{ss} - {t}_{d} ] \approx \frac{{V}_{in} - {V}_{out}}{2 L} ( \frac{{V}_{in}}{{V}_{out}} ) {t}_{d} {t}_{ss} .$$

The method may further comprise determining the steady state pulse width tₛₛ prior to generating the pulse control signal.

The present invention further relates to a power converter comprising a switched power stage configured to generate an output voltage form an input voltage and being controlled by a control law implemented by a controller wherein the controller is configured to generate a pulsed control signal for switching the power stage by varying a pulse width of the pulsed control signal so that square of the pulse width of the pulsed control signal yields a charge to be delivered in a cycle in dependence of a voltage error, wherein the charge to be delivered in cycle depends on the voltage error and the square of the pulse width.

### BRIEF DESCRIPTION OF THE DRAWINGS

Reference will be made to the accompanying drawings, wherein

FIG. 1 shows a prior art switchable buck converter;

FIG. 2 shows a diagram showing an inductor current and a pulse width modulation (PWM) switching signal of a switchable power stage operated in DCM; and

FIG. 3 shows a diagram showing an inductor current and a pulse width modulation (PWM) switching signal of a switchable steady state duty cycle is determined otherwise.

### DETAILED DESCRIPTION OF THE INVENTION

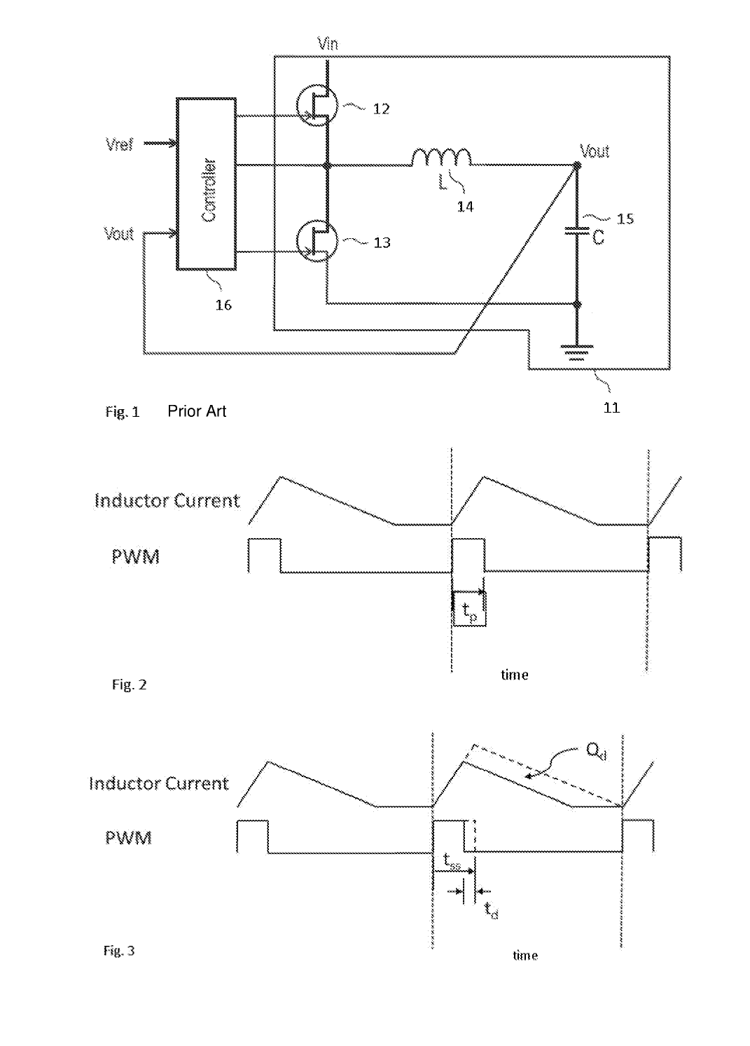

A power converter as shown in FIG. 1 is operated in DCM. As a predictive method of charge mode control, the controller 16 generates a PWM control signal for switching the switchable power stage, wherein the pulse control signal is forwarded to the high-side FET 12 and the complement of the control signal is forwarded to the low side FET 13. The controller 16 generates the pulsed control signal such that a resulting charge Q of the capacitor 15 in a cycle of the PWM signal is given by

$$Q = \frac{{V}_{in} - {V}_{out}}{2 L} ( \frac{{V}_{in}}{{V}_{out}} ) {t}_{p}^{2} ,$$

wherein the pulse width tₚ of the PWM signal is shown versus the resulting inductor current in FIG. 2.

FIG. 3 relates to an operation of the power converter as shown in FIG. 1 when a steady state pulse width tₛₛ is determined otherwise. The controller augments the steady state pulse width tₛₛ of the PWM signal by an additional on-time t_{d} as indicated by the dotted line such that an additional charge Q_{d} in a cycle is given by

$${Q}_{d} = \frac{{V}_{in} - {V}_{out}}{2 L} ( \frac{{V}_{in}}{{V}_{out}} ) {t}_{d} [ 2 {t}_{ss} - {t}_{d} ] \approx \frac{{V}_{in} - {V}_{out}}{2 L} ( \frac{{V}_{in}}{{V}_{out}} ) {t}_{d} {t}_{ss} .$$

The effect on the inductor current is also shown in FIG. 3. It can be observed that the charge increases in the cycle to an extent which is proportional to the area bounded by the dotted line and the solid line of the inductor current.

As in DCM no compensation is necessary, the present invention reduces time and effort needed to compensate. It improves the transition from DCM to CCM and thus results in a more robust power converter.

1. A control method for a power converter configured to generate an output voltage from an input voltage according to a control law controlling a switchable power stage, the method comprising:
determining a charge to be delivered by charge mode control;
generating a pulsed control signal for switching the power stage by varying a square of a pulse width of the pulsed control signal to increase or decrease the charge to be delivered in a cycle in dependence of a voltage error by
predicting when to terminate the pulse of the pulsed control signal so that the square of the pulse width of the pulsed control signal yields the charge to be delivered in the cycle in dependence upon the voltage error, wherein the voltage error is derived from a difference between a reference voltage and the output reference.

2. The method according to claim 1, wherein the pulsed control signal is cyclic.

3. The method according to claim 2, wherein the pulsed control signal is generated such that a resulting charge Q to be delivered in a cycle of the pulsed control signal is given by
$$Q = \frac{{V}_{in} - {V}_{out}}{2 L} ( \frac{{V}_{in}}{{V}_{out}} ) {t}_{p}^{2} ,$$
wherein Vᵢₙ is the input voltage, Vₒᵤₜ is the output voltage, L is an inductance of the switchable power stage and tₚ is the pulse width of the pulsed control signal.

4. The method according to claim 2, wherein the pulsed control signal is generated by augmenting a steady state pulse width tₛₛ by an additional on-time to such that an additional charge Q_{d} to be delivered in a cycle of the pulsed control signal is given by
$${Q}_{d} = \frac{{V}_{in} - {V}_{out}}{L} ( \frac{{V}_{in}}{{V}_{out}} ) {t}_{d} {t}_{ss} .$$

5. The method according to claim 4, further comprising:
determining the steady state pulse width tₛₛ prior to generating the pulse control signal.

6. A power converter comprising a switched power stage configured to generate an output voltage form an input voltage and being controlled by a control law implemented by a controller wherein the controller is configured to determine a charge to be delivered by charge mode control; and to generate a pulsed control signal for switching the power stage by varying a square of a pulse width of the pulsed control signal to increase or decrease the charge to be delivered in a cycle in dependence of a voltage error by
predicting when to terminate the pulse of the pulsed control signal so that the square of the pulse width of the pulsed control signal yields the charge to be delivered in the cycle in dependence upon the voltage error, wherein the voltage error is derived from a difference between a reference voltage and the output reference.

7. The power converter according to claim 6, wherein the pulsed control signal is a cyclic pulsed control signal.

8. The power converter according to claim 7, wherein the controller is further configured to generate the pulsed control signal such that a resulting charge Q to be delivered in a cycle of the pulsed control signal is given by
$${Q}_{d} = \frac{{V}_{in} - {V}_{out}}{L} ( \frac{{V}_{in}}{{V}_{out}} ) {t}_{d} {t}_{ss} ,$$
wherein Vᵢₙ is the input voltage, Vₒᵤₜ is the output voltage, L is an inductance of the switchable power stage and tₚ is the pulse width of the pulsed control signal.

9. The power converter according to claim 7, wherein the controller is configured to generate the pulsed control signal by augmenting a steady state pulse width tₛₛ by an additional on-time to such that an additional charge Q_{d} to be delivered in a cycle of the pulsed control signal is given by
$${Q}_{d} = \frac{{V}_{in} - {V}_{out}}{L} ( \frac{{V}_{in}}{{V}_{out}} ) {t}_{d} {t}_{ss} .$$

10. The power converter according to claim 9, further comprising means for determining the steady state pulse width tₛₛ prior to generating the pulse control signal.
